(19) United States
(12) Patent Application Publication
(10) Pub. No.: US 2013/0277423 A1
(43) Pub. Date: Oct. 24, 2013

(54) ITEM PAYMENT CHECK APPARATUS

(71) Applicant: Fujitsu Frontech Limited, Tokyo (JP)

(72) Inventors: Takashi TOYOKAWA, Tokyo (JP); Kaoru INOUE, Tokyo (JP); Toki HOKAZONO, Tokyo (JP); Ayako HIRASAWA, Tokyo (JP)

(21) Appl. No.: 13/919,525

(22) Filed: Jun. 17, 2013

Related U.S. Application Data
(63) Continuation of application No. PCT/JP2011/055289, filed on Mar. 7, 2011.

(51) Int. Cl. G06Q 20/30

(52) U.S. Cl. CPC G06Q 20/30
USPC 235/375

(57) ABSTRACT

An item payment check apparatus using a shopping basket and including a shopping basket to which an RFID tag is attached; a payment unit configured to perform payment for an item put in the shopping basket, and to record completion of payment in the RFID tag when the payment is completed; and a check unit configured to check, when the shopping basket passes through, whether completion of payment is recorded in the RFID tag, and to perform reporting when completion of payment is not recorded in the RFID tag.

### CROSS-REFERENCE TO RELATED APPLICATIONS

This application is a continuation of PCT application PCT/JP2011/055289, filed on Mar. 7, 2011, the entire contents of which are incorporated herein by reference.

### FIELD

The present invention relates to an item payment check apparatus that uses a shopping basket with an RFID (Radio Frequency Identification) tag.

### BACKGROUND

Nowadays, in a store such as a supermarket, a fraud, so called basket-escaping, to exit the store while keeping unpaid items in the shopping basket, to take away the items. For this matter, for example, shopping baskets in different colors are introduced, and when payment is made at the cashier, the items are moved to a basket in a different color, to indicate that the basket has items for which payment has been made. By doing so, by deploying store person or an observer, to check the color of the basket that customers exiting the store have, and to prevent fraudulent baskets from being carried outside the store.

FIG. 1 is a schematic diagram of the example above. Meanwhile, the arrows in the drawing indicate the flow of the customer. A customer entering the store from a doorway 30 of the store takes a shopping basket 31 for store use first, and moves towards the direction of the arrow a1. The shopping basket 31 is for example a blue basket that indicates that it is a shopping basket for putting in unpaid items. The customer looks for desired items while holding this shopping basket 31, and puts items that the customer wants to purchase in the shopping basket 31.

After that, the customer proceeds in the direction of the arrow a2, puts the shopping basket 31 on the cashier table 32, and makes payment for the items put in the shopping basket 31. A cashier 33 takes out items sequentially from the shopping basket 31, and uses a stationary scanner 34 to read out information of the bar cord recorded on the item for example, to register the item as well as to take in the information in the POS (point of sales) system of the store and to settle the payment. At this time, the cashier 33 moves the paid items to a red shopping basket 35 that indicates that payment has been made, and collects the empty shopping basket 31.

The customer who completed the payment for the items proceeds in the direction of the arrow a3, puts the shopping basket 35 on the sacker table 36, and puts the purchased items in the bag. After that, the customer puts the empty shopping basket 35 on a basket yard 36a or 36b, and the customer proceeds in the direction of the arrow a4, and exits the store from the doorway 30 of the store.

As described above, the store person or the observer monitors the customers who exit the store holding an unpaid blue shopping basket, and when the blue shopping basket 31 for which payment has not been made pass through, gives a warning as taking away unpaid items.

Meanwhile, a system illustrated in FIG. 2 is a diagram explaining a conventional example of a case in which the customers themselves make payment for items using a dedicated payment terminal. In this case, the customer first enters from the doorway 30 of the store, takes a shopping basket 38, and proceeds in the direction of the arrow a1. However, in this conventional example, there is no color distinction of the shopping basket 38.

After that, in the same manner as above, the customer looks for desired items while holding this shopping basket 38, and puts items that the customer wants to purchase in the shopping basket 38, and proceeds in the direction of the arrow a2, and puts the shopping basket 38 on the cashier table 39. A checker 40 takes out items sequentially from the shopping basket 38, uses an item registration terminal 41 to register the items and to take in information in the POS system of the store. Then, the customer receives a receipt 42 with a bar code, proceeds in the direction of the arrow a3′ and moves towards a payment terminal 43a or 43b provided in the store.

After that, the customers themselves operates the payment terminal 43a or 43b, makes the payment terminal 43a or 43b read in the bar cord of the receipt 42, and make payment for the billed amount by cash or credit card, electronic money and the like. Then, while keeping the items in the shopping basket 38, proceeds in direction of the arrow a3″, and passes through a gate 44 and moves towards a sacker table 45. At this time, the store person or observer monitors near the gate 44 monitors that the customer completes payment for the items without fraud.

The customer then puts the purchased items in the bag on the sacker table 45, returns the shopping basket 38 to a basket yard 45a or 45b, proceeds in the direction of the arrow a4, and exits the store from the doorway 30 of the store.

Meanwhile, Patent Document 1 is an invention in which item information of items selected by the customer in the sales space is written into the RFID tag of the shopping basket, and the store person checks the item information of the RFID tag of the shopping basket and the items in the shopping basket and performs the checkout process by a POS terminal device.

Meanwhile, Patent Document 2 is an invention in which using a touch screen provided at a self-cashier kiosk, the customer purchases an item of merchandise detected by an RFID reader, and is an invention in which theft detection software of the self-cashier kiosk judges whether or not payment for the item of the purchased merchandise has been made, and when payment has not been made, the alarm is activated.
Patent Document 1: Japanese Laid-open Patent Publication No. 2006-119687
Patent Document 2: Japanese National Publication of International Patent Application No. 2010-530560

However, the conventional payment check apparatus has following problems. For example, in the conventional example dividing the color of the shopping basket for which payment has been made and the shopping basket for which payment has not been made, two types of shopping baskets of different colors need to be prepared, and further, a store person or an observer needs to be deployed at the doorway 30 of the store.

In addition, in the system in which the customers themselves make payment using a dedicated payment terminal, there certainly is no need for the cashier of the store, but there is a need to deploy a store person or an observer to check fraud, requiring manpower for monitoring in the same manner as the above.

Furthermore, in the system in which the customers themselves make payment using a dedicated payment terminal, it is impossible to prevent fraud check with certainty. FIG. 3 is a diagram explaining this. Meanwhile, the configurations of the checker 40, the payment terminals 43a, 43b, the gate 44, the sacker table 45 are the same as in FIG. 2 mentioned above.

In FIG. 3, A and B represent customers waiting for payment. Meanwhile, it is assumed that the customer A for example has the receipt 42 for making payment of 5000 yen, and the customer B has for example the receipt 42 for making payment of 100 yen.

In this condition, as illustrated in FIG. 3 for example, when the customers A and B moves to the payment terminals 43a together, and the customers A and B exchange the respective receipts, performs a payment process for the receipt 42 for the small amount, conceals the receipt 42 for the large amount, and passes through the gate 44. In this case, the store person or the observer thinks that the customer A and B performed the payment process by the payment terminal 43a, and passes the gate 44 easily. Therefore, in a system in which the customers themselves make payment using the designated payment terminals 43a, 43b, it is impossible to check the fraud with certainty.

### SUMMARY

The present invention provides an item payment check apparatus that does not require a store person or an observer for checking shipping baskets with unpaid items, and does not require the use of shopping baskets in different colors. Furthermore, an item payment check apparatus that is capable of checking fraud with certainty even in a system in which customers themselves may payment using a dedicated terminal is provided.

An item payment check apparatus is provided in which an RFID tag is attached to a shopping basket used in a store; when registration and payment for an item put in the shopping basket are completed in the registration and payment unit, completion of registration and payment is recorded in the RFID tag; and in a check unit, when the shopping basket passes through, information recorded in the RFID tag is read out, and when information indicating completion of the registration and payment is not recorded, reporting of an unpaid shopping basket being taken out is performed to a store person and a security guard by ringing an alarm.

In addition, an item payment check apparatus is provided in which in the same manner as above, an RFID tag is attached a shopping basket used in a store; after a registration process for an item put in the shopping basket is performed at a registration unit, when customers themselves complete payment for the item using a payment terminal, completion of payment is recorded in the RFID tag; and in the check unit, when the shopping basket passes through, information recorded in the RFID tag is read out, and when information indicating completion of the payment is not recorded, reporting of an unpaid shopping basket being taken out is performed to a store person and a security guard by ringing an alarm.

In addition, in the configuration, when the customers themselves perform payment for the item using a payment terminal and the number of items and the total amount recorded on a registration certificate such as a receipt issued in the registration unit do not match the number of items and the total mount recorded on the RFID tag, the alarm is rung.

Furthermore, in the configuration, when the shopping basket passes through the check unit after a certain time has passed since the time recorded in the RFID tag at the time of payment or at the time of registration, the alarm is rung.

According to the present invention, using a shopping basket to which an RFID tag is attached, fraudulent taking out of a shopping basket with unpaid items outside the store may be prevented. In addition, in a case in which customers themselves make payment using a payment terminal, a fraudulent payment process may also be prevented. Furthermore, there is no need to prepare shopping baskets in different colors, and there is no need to deploy a store person or a security guard either.

### BRIEF DESCRIPTION OF DRAWINGS

FIG. 1 is a schematic diagram illustrating a conventional item payment check apparatus.

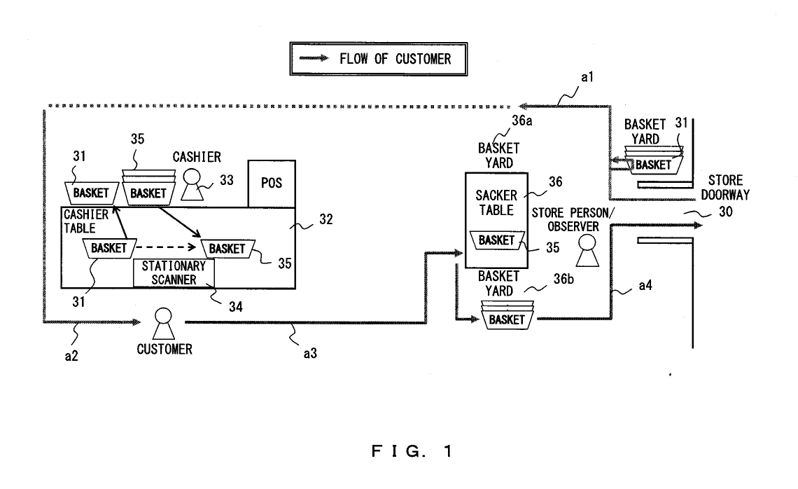

FIG. 2 is a schematic diagram illustrating a conventional item payment check apparatus with which customers make payment using a payment terminal.

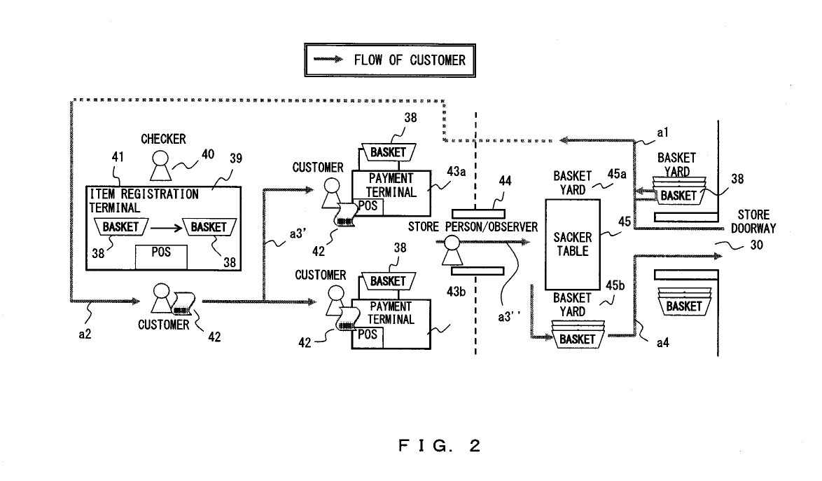

FIG. 3 is a schematic diagram illustrating a problem of a conventional item payment check apparatus with which customers make payment using a payment terminal.

FIG. 4 is a diagram illustrating a system configuration of an item payment check apparatus according to embodiment 1.

FIG. 5 is a schematic diagram of a shopping basket used in embodiments 1 and 2.

FIG. 6 is a diagram illustrating a data configuration stored in a memory of an RFID tag.

FIG. 7 is a flowchart illustrating processes at a registration/payment unit in embodiment 1.

FIG. 8 is a flowchart illustrating processes at a gate in embodiment 1.

FIG. 9 is a diagram illustrating a system configuration of an item payment check apparatus according to embodiment 2.

FIG. 10 is a flowchart illustrating processes at a registration unit in embodiment 2.

FIG. 11 is a diagram illustrating a description example on a receipt.

FIG. 12 is a flowchart illustrating processes at a payment terminal in embodiment 2.

### DESCRIPTION OF EMBODIMENTS

Hereinafter, embodiments of the present invention are explained with reference to drawings.

### Embodiment 1

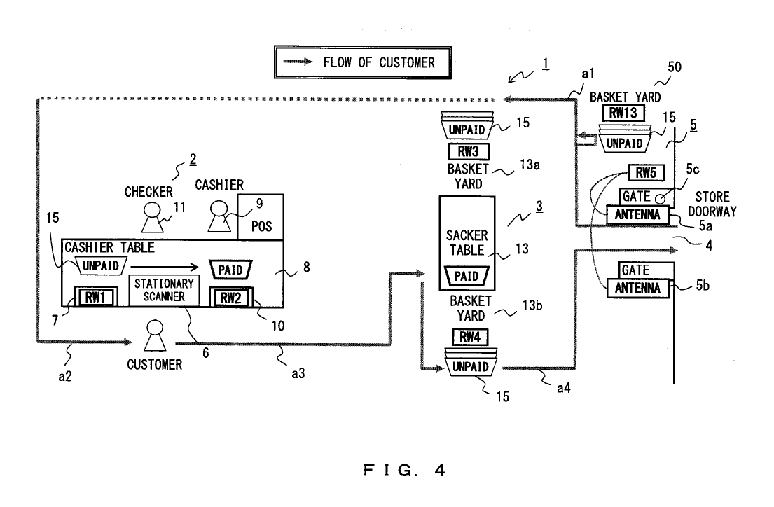

FIG. 4 is a diagram illustrating the system configuration of an item payment check apparatus 1 according to the present embodiment.

This apparatus includes a registration/payment unit 2 to perform registration and payment for an item by a checker and a cashier, a sacker unit 3 for customers to move items from the shopping basket to the bag, and a gate provided at a doorway 4 of the store. The registration/payment unit 2 includes a stationary scanner 6, and this terminal is connected to the POS system of the store, to manage sales information of respective items and goods that was taken in at the time of item registration.

In addition, in the registration/payment unit 2, a shopping basket yard table 7 to put a shopping basket described later is attached to a cashier table 8, and a reader-writer (RW1) is provided on the basket yard table 7. In addition, a basket yard table 10 is attached in front of a casher 9 of the cashier table 8, and the reader-writer (RW2) is provided in front of basket yard table 10 too.

The sacker unit 3 is constituted by a sacker table 13, and basket yards 13a, 13b, and empty baskets are put on the basket yards 13a, 13b. In addition, a reader-writer (RW3) is provide on the basket yard 13a, and a reader-writer (RW4) is provided on the basket yard 13b.

The gate 5 is a place to automatically check the shopping basket, which is constituted by a reader-writer (RW5), antennas 5a, 5b and a speaker 5c. When a shopping basket passes through, the gate 5 detects information transmitted from the RFID tag described later, and monitors the passing of an unpaid shopping basket.

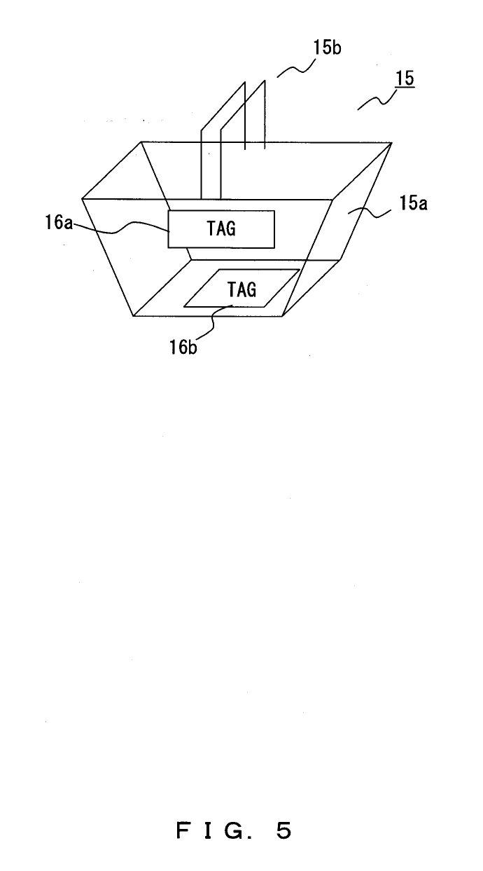

Meanwhile, FIG. 5 is a schematic diagram of a shopping basket 15 used for the present embodiment, which is constituted by an item storage unit 15a and a grip unit 15b, where an RFID tag 16a is attached to the side of the item storing unit 15a, and an RFID tag 16b is attached to the bottom side.

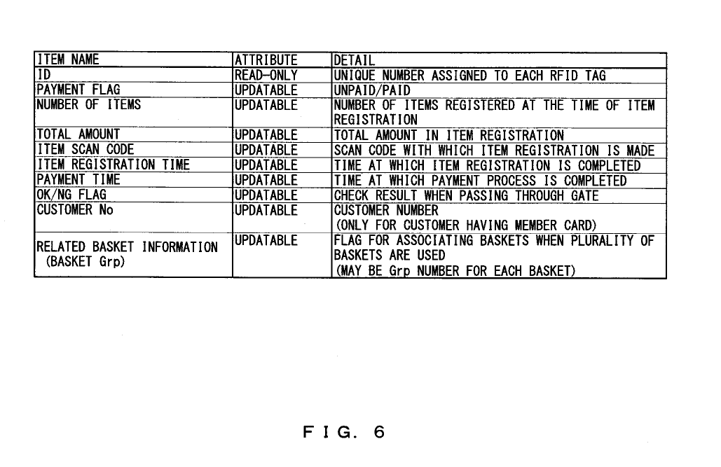

The RFID tags 16a and 16b has an antenna on an IC chip, and performs read and write on information stored in the memory in the IC chip with the reader-writer (RW) through the built-in antenna. FIG. 6 is a diagram illustrating the memory configuration of the RFID tags 16a and 16b used for the present example.

As illustrated in the drawing, in the RFID tags 16a and 16b, data of “ID”, “payment flag”, “number of items”, “total amount”, “item scan code”, “item registration time”, “payment time”, “OK/NG flag”, “customer No.” and “related basket information” are configured in a storable manner. Here, the “ID” is a unique number assigned to the RFID tag, the “payment flag” is a flag that indicates whether or not payment for items put in the shopping basket 15 has been completed, the “number of items” is the number of items registered at the time of item registration, and the “total amount” is the total amount of purchased items at the time of item registration.

Meanwhile, the “item scan code” represents the scan code for with which item is registered, the “payment time” represents the time at which payment is completed, the “OK/NG flag” represents the check result at the time of passing the gate. Furthermore, the “customer No.” represents the customer number when the customer has a member card, and the “related basket information” is a flag to associate the baskets when the customer uses a plurality of baskets. Meanwhile, for the “related basket information”, the configuration may be made so that a group number is set for each basket.

In the configuration above, the processing operations in the present example are explained along the flow of customers illustrated in FIG. 4.

Customers first enter the store from the doorway 4 of the store, take the shopping basket 15 to which the RFID tags 16a and 16b are attached, and proceed in the direction of the arrow a1. After that, look for desired items, put items they want to purchase in the shopping basket 15, proceed in the direction of the arrow a2, and move towards the registration/payment unit 2.

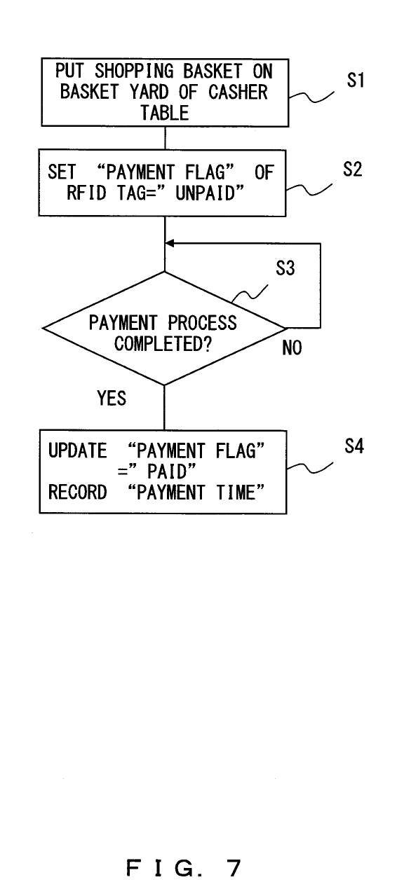

The flowchart in FIG. 7 illustrates the processes in the registration/payment unit 2 in the present example. First, the customer puts the shopping basket 15 on the basket yard table attached on the cashier table 8 (step (hereinafter, represented by S) 1). The reader-writer (RW1) is provided on the basket yard table 7 as described above, and communication between the RFID tag 16b attached on the bottom side of the shopping basket 15 and the reader-writer (RW1) becomes available. Here, by the control signal from the reader-writer (RW1), the “payment flag” of the RFID tag 16b is set to “Not yet” (S2). (Usually, it is common that when entering the store from the doorway 4 of the store, the customer takes the shopping basket 15 from the basket yard 50 and start shopping, but since start of shopping while taking a shopping basket left in the store and the “payment flag” being “paid” could also be assumed, the “payment flag” is updated to “unpaid” when the shopping basket 15 is put on the basket yard table 7.)

Next, judgment is made as to whether the payment process has been completed (S3), and when the payment process has not been completed (NO in S3), the processes are repeated. This judgment is made according to whether the “received total” key in the POS system has been pressed or not, for example in the present example. Therefore, after the registration process by checker 11 is performed, the shopping basket 15 is moved to the basket yard table 10 and communication between the reader-writer (RW2) and the RFID tag 16b becomes available, when the “received total” key is pressed by the casher 9, the payment flag” is updated to “paid” (S4). In addition, the current time (payment time) is recorded in the “payment time” area of the RFID tag 16b (S4). Meanwhile, for the cashier 9 and the checker 11, one store person may perform processes for both.

The customer who completed the processes above proceeds in the direction of the arrow a3, puts the shopping basket 15 on the sacker table 13 and puts the purchased items in the bag. After that, the empty shopping basket 15 is put on the basket yards 13a or 13b. As described above, the reader-writer (RW3) is provided on the basket yard 13a, the reader-writer (RW4) is provided on the basket yard 13b, the RFID tag 16b attached to the shopping basket 15 and the reader-writer (RW3) or (RW4) performs communication, and the “payment flag” of the RFID tag 16b is updated to “unpaid”.

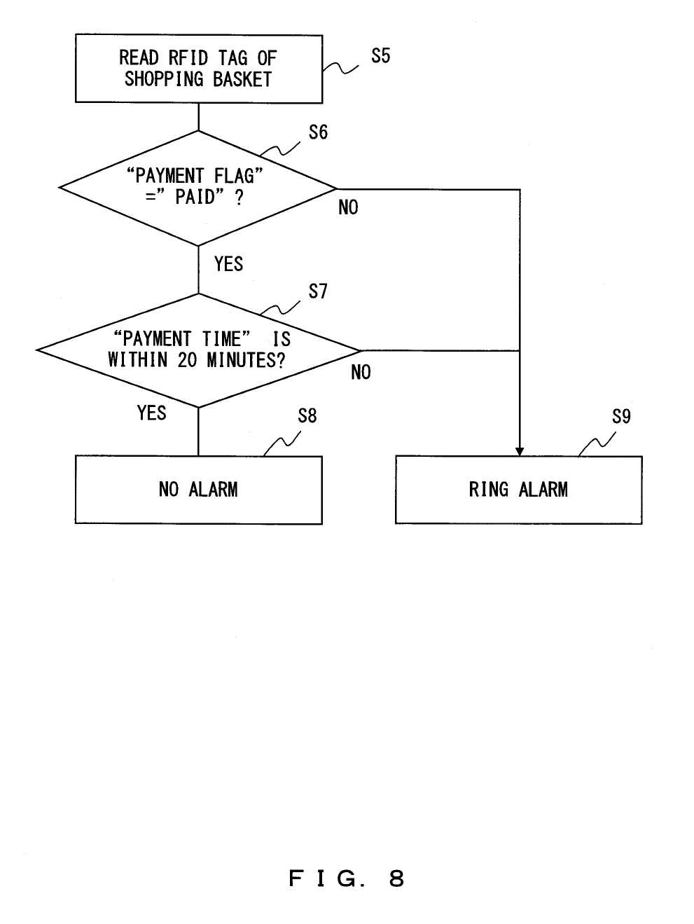

After that, the customer proceeds in the direction of the arrow a4, and passes the gate 5 provided at the doorway 4 of the store. At this time, a reader-writer (RW5) is provided at the gate 5, and the passing of an unpaid shopping basket 15 is monitored according to the flowchart in FIG. 8.

That is, the reader-writer (RW5) reads information transmitted from the RFID tags 16a and 16b attached to the shopping basket 15 through the antennas 5a, 5b (S5), and judges whether or not the “payment flag” is “paid” (S6). When it is determined that the “payment flag’ is “paid” (YES in S6), further, whether the “payment time” was for example within 20 minutes (S7). This judgment is made by reading out data of the payment time recorded in the process (S4) illustrated in FIG. 7 described above and comparing it with the current time.

Here, when it is determined as within 20 minutes (YES in S7), it is determined that no fraud is made, and no alarm is rung at the passing of the gate 5 (S8).

On the other hand, when the “payment flag” is “unpaid” in the judgment (S6) (NO in S6), it is determined as the shopping basket 15 to which payment has not been made, and an alarm is rung by driving the speaker 5c (S9). By this alarm, the store person or an observer of the store determines that an unpaid shopping basket 15 exits the store, and may check the shopping basket 15. Therefore, according to the present embodiment, a check of an unpaid shopping basket 15 may be performed based on information of the RFID tags 16a and 16b attached to the shopping basket 15, and without a need to deploy a store person or an observer in the vicinity of the gate 5 particularly, an unpaid shopping basket 15 may be checked.

Furthermore, even in a case in which the “payment flag” is “paid” (YES in S6), when the data of the “payment time” has passed 20 minutes or more for example (NO in S7), it is an abnormally time for a work done on the sacker unit 3, and in this case, it is also determined that there is a fraud, and the alarm is rung by driving the speaker 5c (S9).

Therefore, according to the present embodiment, based on information of the RFID tags 16a and 16b attached to the shopping bag 15, an unpaid shopping basket 15 exiting the store may be monitored with more certainty. In addition, according to the present embodiment, there is no need to use shopping baskets in different colors.

Meanwhile, for shopping baskets collected after being brought outside the store and shopping baskets left in the store, by put them on a basket yard 50 provided near the doorway, the “payment flag” of the RFID tag 16b is updated to “unpaid” by the control signal from a reader-writer (RW13) provided in the basket yard 50.

Meanwhile, while the configuration in the explanation of the present embodiment above is made so that the alarm is rung when 20 minutes or more passes after the payment completion time, but of course it is not limited to 20 minutes, and considering the structure of the store and congestion of customers, it may be set to a time shorter than 20 minutes, and may be set to a time longer than 20 minutes.

In addition, in the explanation of the present embodiment above, it is explained that each reader-writer (RW) performs communication with the RFID tag 16b attached to the bottom side of the shopping basket 15, but when each reader-writer (RW) is provided on the side of the basket yard tables 7, 10, the basket yards 13a, 13b, communication is of course made with the RFID tag 16a attached to the side of the shopping basket 15.

Furthermore, in the present embodiment, the configuration is made so that when the shopping basket is fraudulently taken out, the speaker 5c is driven and alarm is rung, but a light emission may be made from an alarm light and the like at the time when the alarm is rung or separately, to report to a store person or an observer of the store.

### Embodiment 2

Next, embodiment 2 of the present invention is explained.

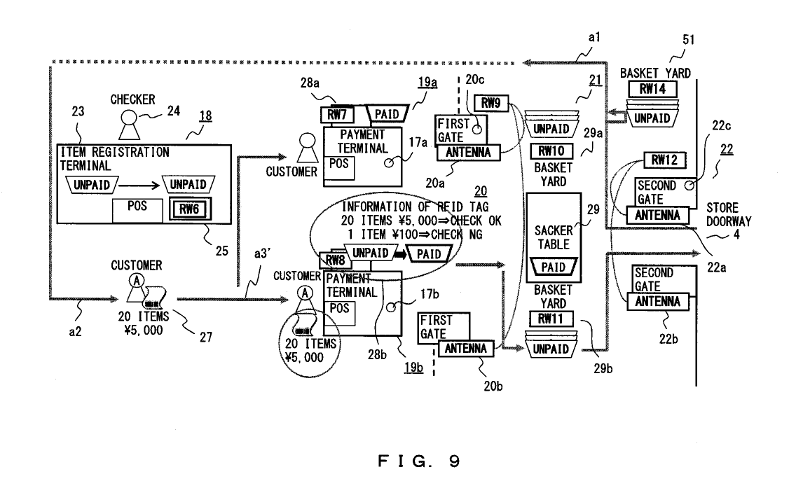

FIG. 9 is a diagram illustrating the system configuration of an item payment check apparatus of according to the present embodiment. Meanwhile, the present embodiment 2 is different from embodiment 1 described above, and the customers themselves operate the payment terminal while holding a receipt, and perform the payment (settlement) process.

The system includes a registration unit 18 to perform item registration by a checker 24, payment terminals 19a, 19b with which the customers themselves make payment (settlement), a first gate 20, a sacker unit 21 to move items from the shopping basket to the bag, and a second gate 22 provided at the doorway 4 of the store. An item registration terminal 23 is provided in the registration unit 18, and a registration process of the purchased item is performed by the checker 24. In addition, in the registration unit 18 of the present embodiment, a basket yard table 25 is attached, and a reader-writer (RW6) is provided in the basket yard table 25. In addition, in the present example, when the registration process of the item by the registration unit 18 is completed, a receipt 27 is issued.

The payment terminals 19a, 19b are connected to the POS system of the store, and the customers themselves operate the payment terminal 19a or 19b and make payment. Meanwhile, a basket yard table 28a is provided in a payment terminal 19a, and a reader-writer (RW7) is provide in the basket yard table 28a. In a similar manner, a basket yard table 28b is provided in a payment terminal 19b, and a reader-writer (RW8) is provide in the basket yard table 28b. Further, a speaker 17a is provided in the payment terminal 19a, and a speaker 17b is provide in the payment terminal 19b.

The first gate 20 is a place to automatically check the shopping basket, which is constituted by a reader-writer (RW9), antennas 20a, 20b and a speaker 20c. When a shopping basket passes through, the first gate 20 detects information transmitted from the RFID tag, and monitors the passing of an unpaid shopping basket.

In a similar manner to embodiment 1 described above, the sacker unit 21 is constituted by a sacker table 29, and basket yards 29a, 29b, and empty baskets are piled on the basket yards 29a, 29b. In addition, a reader-writer (RW10) is provide on the basket yard 29a, and a reader-writer (RW11) is provided on the basket yard 29b.

The second gate 22 is provided at the doorway 4 of the store, and in a similar manner to the first gate 20, detects information transmitted from the RFID tag when a shopping basket passes through, and monitors the passing of an unpaid shopping basket, which is constituted by a reader-writer (RW12), antennas 22a, 22b and a speaker 22c.

In the configuration above, the processing operations in the present example are explained along the flow of customers illustrated in FIG. 9. Meanwhile, as the shopping basket used in the present embodiment, the shopping basket 15 in the configuration in FIG. 5 explained in embodiment 1 described above is also used.

First, customers enter the store from the doorway 4 of the store, take the shopping basket 15, and proceed in the direction of the arrow a1. After that, look for desired items, put items they want to purchase in the shopping basket 15, proceed in the direction of the arrow a2, and move towards the registration unit 18.

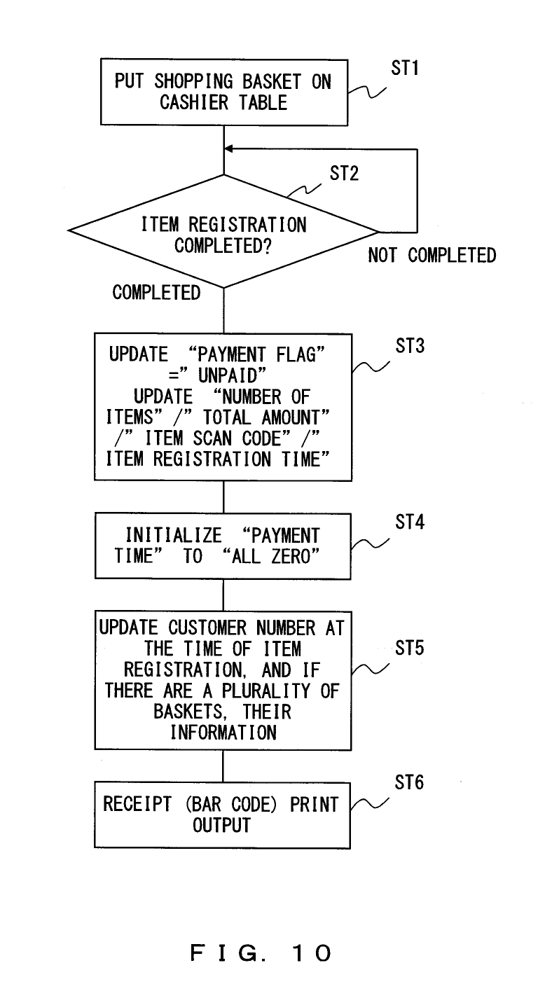

The flowchart in FIG. 10 illustrates the processes in the registration unit 18. First, the customer puts down the shopping basket 15 (step (hereinafter, represented by ST) 1). Next, the checker 24 takes out items from the shopping basket 15, and performs item registration using the item registration terminal 23. After that, when the registration process of all items in the shopping basket 15 is completed, the empty shopping basket 15 is put on the basket yard table 25.

By this work, the reader-writer (RW6) provided in the basket yard table 25 becomes available for communication with the RFID tag 16b described above attached to the shopping basket 15. In this condition, when a key corresponding to “tentative closing” for example in the POS system is pressed, it is determined that the item registration is finished (YES in ST2).

Next, the reader-writer (RW6) transmits a control signal to the RFID tag 16b attached to the shopping basket 15, updates the “payment flag” of the RFID tag 16b to “unpaid”, and further records the information of the number of items registered this time in the storage area of the “number of items”, records the data of the total amount in the area of the “total amount”, and records the “item scan code”. Further, the data of the “item registration time” is updated (ST3). (Even when the shopping basket used by the customer is a use of a shopping basket left in the store and the “payment flag” is set to “paid”, the payment is updated to “unpaid” by the process.)

Next, the “payment time” is initialized (“0”) (ST4), and further the customer number at the time of item registration, and when a plurality of baskets are used, its information, are updated (ST5). Meanwhile, the input of the customer number is in the case in which the customer has a member card and the like of the store. In addition, when one customer uses a plurality of shopping baskets, for example a group number is recorded for the first shopping basket, and the same number is recorded for the other baskets.

Next, the data of the number of items and the total amount described above is printed on the receipt (registration certificate) 27, and a corresponding bar code is further created and the receipt 27 is printed and output (ST6).

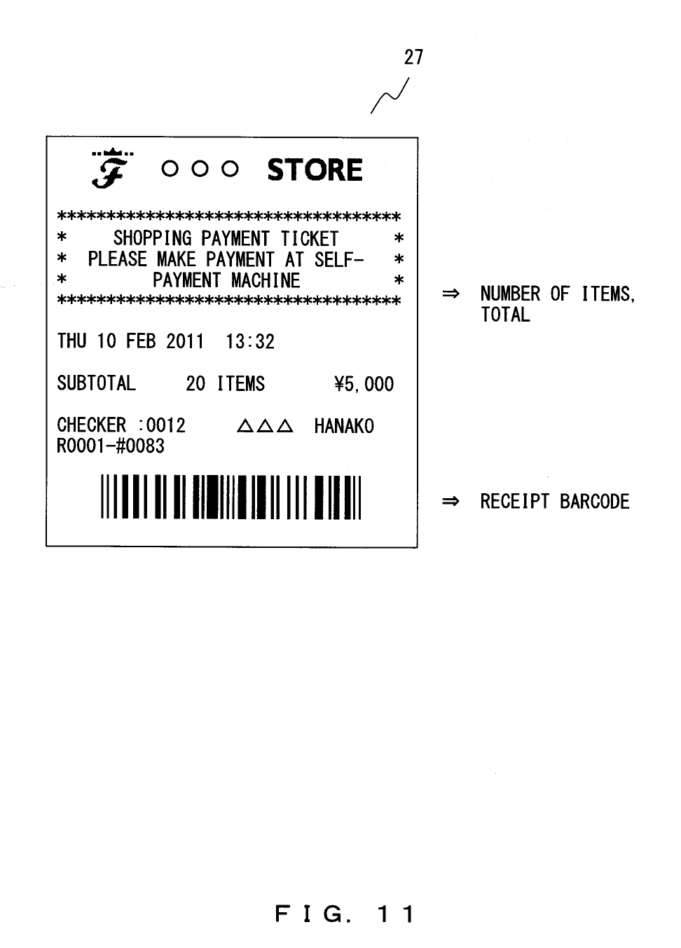

FIG. 11 is a diagram illustrating an example of the description details of the receipt 27. On the receipt 27, at least the information of the number of items and the total amount described above is recorded, and the information is embedded in a bar code. The customer receives the receipt 27, proceeds in the direction of the arrow a3′, and moves towards the payment terminal 19a or 19b.

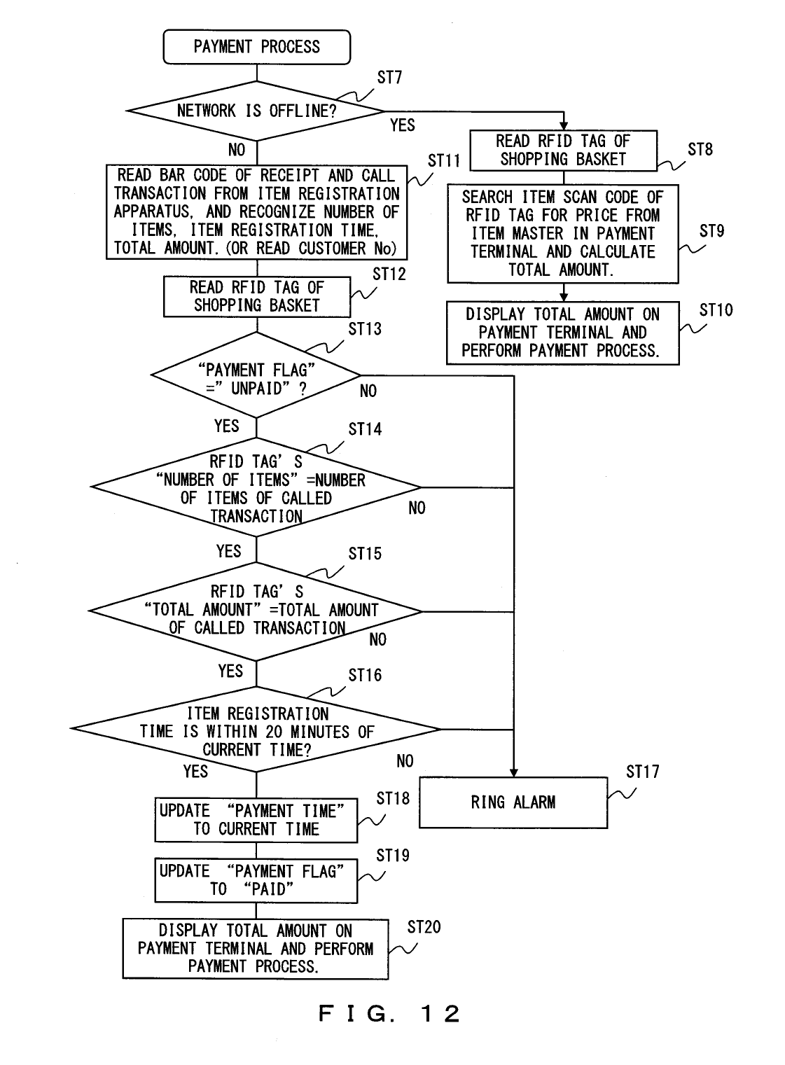

Next, the customer operates the payment terminal 19a or 19b and performs the payment process (settlement process). FIG. 12 is a flowchart illustrating this settlement process.

First, the customer puts the shopping basket 15 with items on a basket yard table 28a or 28b provided in the payment terminal 19a or 19b. By this process, communication between the reader-writer (RW7) or (RW8) provided in the basket yard table 28a or 28b and the RFID tag 16b attached to the shopping basket 15 becomes available.

Next, whether the network is offline is judged (ST7). Here, when the network is offline (YES in ST7), the data of the RFID tag 16b attached to the shopping basket 15 is read out (ST8), the item scan code of the RFID tag is searched for the price from an item master in the payment terminal, the total amount is calculated (ST9), the total amount is displayed on the payment terminal, and the payment process is performed (ST10). By this process, even when the payment terminal 19a or 19b is in the offline status in which the payment terminal may not communicate with a server or other cashiers, it is possible to calculate the total amount using the information of the item scan code of the RFID tag 16b, and to perform the payment process. Meanwhile, when the network becomes online, the transaction information (the item scan code, price, total amount, payment information and the like) is transmitted to the server.

On the other hand, when the network is online (NO in ST7), the payment terminals 19a or 19b is made to read out the bar code of the receipt 27, the transaction is called from an item registration apparatus in the payment terminal 19a and 19b, and the number of items, the item registration time, the total amount recorded in the receipt 27 are recognized (ST11). Meanwhile, when the customer is a member, the information of the customer No. may be read out, and the information mentioned above may be obtained from the server and the like.

Next, the reader-writer (RW7) or (RW8) reads out the information of the RFID tag 16b attached to the shopping basket 15 (ST12), and judges whether the “unpaid flag” is set to “unpaid” (ST13). Here, when the “unpaid flag” is set to “unpaid” (YES in ST13), information is further read out from the area of the “number of items” of the RFID tag 16b, whether it matches the information of the number of items in the receipt 27 mentioned above is judged (ST14). Here, when the information of the number of items matches as well, whether the data of the total amount match is judged (ST15).

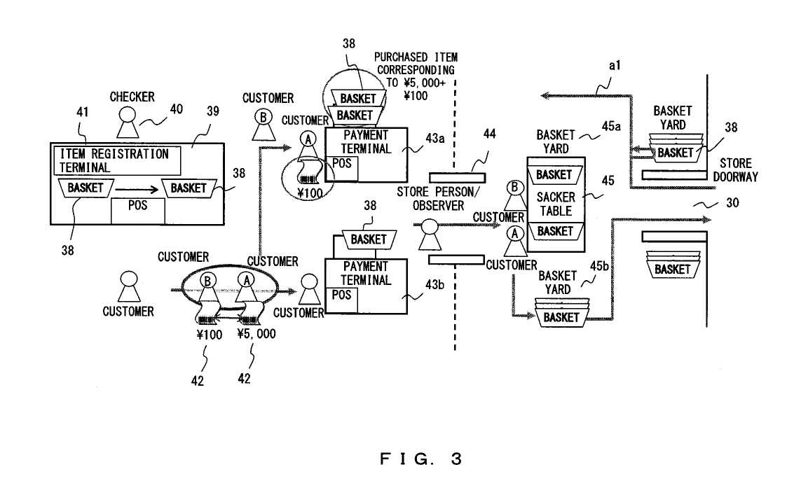

When all the judgments above (ST13-ST15) are all YES and the next judgment (ST16) is also YES, there is no fraud, but any of the judgments above is NO, there is a possibility of fraud. Here, a case in which a fraud explained in the conventional example described above is exercised is considered. The fraud described above explained in FIG. 3 is a fraud in which a customer A holding a payment receipt for 5000 yen and a customer B holding a payment receipt for 100 yen conspire and move to the same payment terminal, make payment for the payment receipt for 100 yen only, and discards the payment receipt for 5000 yen to escape from payment.

However, when the above act is done in the system of the present embodiment, both of the judgment (ST14) and the judgment (ST15) become NO. That is, because the number of the items and the total amount recorded in the receipt 27 and the number of items and the total amount recorded in the RFID tag 16b do not match. Therefore, in this case, the speaker 17a or 17b is driven and to ring the alarm (ST17), and the fraud is reported. Meanwhile, when the numbers of the items in the receipt 27 of the customer A and the receipt 27 of the customer B coincidentally match (YES in ST14), it is usually unlikely that the total amounts also match (NO in ST15), and the alarm is rung in this case as well (ST17), and the fraud is reported to the store person or the observer.

Furthermore, even in a case in which the number of items and the total amount match, in this embodiment, whether the item registration time is within 20 minutes with respect to the current time is judged (ST16). Here, when 20 minutes or more has passed at the current time since the item registration time (NO in ST16), the alarm is rung in the same manner as the above (ST17). In this case, it is unlikely that a time more than 20 minutes or more is spent for the move from the registration unit 18 to the payment terminal 19a or 19b and the operation, and it is determined that there is a fraud in this case as well, and the alarm is rung (ST17).

Therefore, by the process above, based on the information of the receipt 27 and the RFID tag 16b attached to the shopping basket 15, check of an unpaid shopping basket 15 may be performed with certainty.

After that, the payment terminal 19a or 19b transmits the control signal from the reader-writer (RW7) or (RW8) to 16b attached to the shopping basket 15, updates the “payment time” to the current time (ST18), and updates the “payment flag” to “paid” (ST19). Furthermore, the total amount is displayed on the payment terminals 19a or 19b, and the payment process is performed (ST20).

Next, the customer holds the shopping basket 15 and passes through the first gate 20. At this time, a reader-writer (RW9) is provided in the first gate 20, and data is read out from the “payment flag” of the RFID tag 16b attached to the shopping basket 15. Here, when the “payment flag” is “unpaid”, the speaker 20c is driven and the alarm is rung. In addition, the alarm is also rung when 20 minutes or more has passed at the current time since the “payment time”.

Therefore, in the first gate 20, the alarm also rings when the “payment flag” is “unpaid”, and the store person or the observer is able to determine as an unpaid shopping basket and check the shopping basket. In addition, when 20 minutes or more has passed from the above payment process, the alarm also rings, making it possible to monitor fraudulent unpaid shopping basket.

Furthermore, in the present embodiment, the second gate 22 is provided when passing through the sacker unit 21 and through the doorway 4, and in the same manner as above, when the “payment flag” is “unpaid”, the speaker 22c is driven, the alarm rings, and the store person or the observer is able to determine as an unpaid shopping basket and check the shopping basket. Furthermore, when 20 minutes or more has passed from the payment process, the alarm also rings, making it possible to prevent a fraudulent shopping basket 15 being taken outside the store.

Therefore, according to the present embodiment, an unpaid shopping basket 15 being taken outside the store may also be monitored with more certainty, based on information of the RFID tags 16a and 16b attached to the shopping basket 15. In addition, according to the present embodiment, there is no need to use shopping baskets in different colors.

In addition, in the explanation of the embodiment above, it is explained that each reader-writer (RW) performs communication with the RFID tag 16b attached to the bottom side of the shopping basket 15, but when each reader-writer (RW) is provided on the side of the basket yard tables 25, 28a, 28b, communication is of course made with the RFID tag 16a attached to the side of the shopping basket 15.

Furthermore, in the present embodiment, the configuration is also made so that when the shopping basket is fraudulently taken out the alarm is rung, but a light emission may be made from an alarm light and the like at the time when the alarm is rung or separately, to report to a store person or security guard of the store.

In addition, in the explanation of the present embodiment, the configuration is made so that the first gate 20 is provided, and also the second gate 22 is provide, but the present invention is also capable of preventing an unpaid shopping basket 15 being taken outside the store, even in a configuration in which the gate is provided at either one.

Furthermore, in the explanation of the present embodiment, the “OK/NG flag” of the RFID tags 16a and 16b is not used, but the configuration may also be made so that, for example with the passing through of the first gate 20 described above, if there is no fraud, an OK flag (“1”) is set in the area of the “OK/NG flag” by the reader-writer (RW9), and with the passing through of the second gate 22, the “OK/NG flag” is checked, and when the OK flag (“1”) is set, the check of the “payment flag” is not performed.

Meanwhile, for the customer who passed through the first gate, by putting the empty shopping basket 15 on the shopping basket yard 29a or 29b, by control signal from a reader-writer (RW10, RW11) provided in the shopping basket yard 29a or 29b, the “payment flag” of the RFID tag 16b is updated to “unpaid”. In addition, for shopping baskets collected after being brought outside the store and shopping baskets left in the store, by put them on a basket yard 51 provided near the doorway, the “payment flag” of the RFID tag 16b is updated to “unpaid” by the control signal from a reader-writer (RW14) provided in the basket yard 51.

1. An item payment check apparatus comprising:
a shopping basket to which an RFID tag is attached;
a registration/payment unit configured to perform registration and payment for an item put in the shopping basket, and to record completion of payment in the RFID tag when the registration and payment are completed; and
a check unit configured to check, when the shopping basket passes through, whether completion of payment is recorded in the RFID tag, and to perform reporting when completion of payment is not recorded in the RFID tag.

2. The item payment check apparatus according to claim 1, wherein
the registration/payment unit also records, when performing the recording of payment, information of a payment time in the RFID tag, and when the shopping basket passes through the check unit after a time set in advance has passed since the payment time, the check unit performs reporting.

3. The item payment check apparatus according to claim 1, wherein
the RFID tag is attached to a side part and a bottom part of the shopping basket.

4. The item payment check apparatus according to claim 1, wherein
the check unit is provided at a doorway of a store.

5. An item payment check method comprising:
using a shopping basket to which an RFID tag is attached;
performing a registration/payment process to perform registration and payment for an item put in the shopping basket, and to record completion of payment in the RFID tag when the registration and payment are completed; and
performing a check process to check, when the shopping basket passes through a position set in advance, whether completion of payment is recorded in the RFID tag, and to perform reporting when completion of payment is not recorded in the RFID tag.

6. The item payment check method according to claim 5, wherein
in the registration/payment process, when performing the recording of payment, information of a payment time is also recorded in the RFID tag, and when the shopping basket passes through the position after a time set in advance has passed since the payment time, reporting is performed.

7. An item payment check apparatus comprising:
a shopping basket to which an RFID tag is attached;
a registration unit configured to perform registration for an item put in the shopping basket and to issue a registration certificate on which information of a number of items put in the shopping basket and a total amount is recorded; and
a payment unit in which a user of the shopping basket performs payment of an item for which the registration is completed using the registration certificate, and configured to perform reporting when information of the number of items and the total amount recorded on the registration certificate does not match information recorded in the RFID tag.

8. The item payment check apparatus according to claim 7, wherein
the RFID tag is attached to a side part and a bottom part of the shopping basket.

9. An item payment check apparatus comprising:
a shopping basket to which an RFID tag is attached;
a registration unit configured to perform registration for an item put in the shopping basket and to issue a registration certificate on which information of a number of items put in the shopping basket and a total amount is recorded;
a payment unit in which a user of the shopping basket performs payment of an item for which the registration is completed using the registration certificate, and configured to record completion of payment in the RFID tag when information of the number of items and the total amount recorded on the registration certificate matches information recorded in the RFID tag and payment of the total amount is completed; and
a check unit configured to check, when the shopping basket passes through, whether completion of payment is recorded in the RFID tag, and to perform reporting when completion of payment is not in the RFID tag.

10. The item payment check apparatus according to claim 9, wherein
the payment unit also records, when performing the recording of payment, information of a payment time in the RFID tag, and when the shopping basket passes through the check unit after a time set in advance has passed since the payment time, the check unit performs reporting.

11. The item payment check apparatus according to claim 9, wherein
the RFID tag is attached to a side part and a bottom part of the shopping basket.

12. The item payment check apparatus according to claim 9, wherein
the check unit is provided in front of and behind a sacker table where a customer moves an item to a bag.

13. The item payment check apparatus according to claim 9, wherein
the check unit is provided at a doorway of a store.

14. An item payment check method comprising:
using a shopping basket to which an RFID tag is attached;
performing a registration process to perform registration for an item put in the shopping basket and to issue a registration certificate on which information of a number of items put in the shopping basket and a total amount is recorded;
performing a payment process in which a user of the shopping basket performs payment of an item for which the registration is completed using the registration certificate, and reporting is performed when information of the number of items and the total amount recorded on the registration certificate does not match information recorded in the RFID tag.

15. An item payment check method comprising:
using a shopping basket to which an RFID tag is attached;
a registration process to perform registration for an item put in the shopping basket and to issue a registration certificate on which information of a number of items put in the shopping basket and a total amount is recorded;
a payment process in which a user of the shopping basket performs payment of an item for which the registration is completed using the registration certificate, and completion of payment is recorded in the RFID tag when information of the number of items and the total amount recorded on the registration certificate matches information recorded in the RFID tag and payment of the total amount is completed; and
a check process to check, when the shopping basket passes through a position set in advance, whether completion of payment is recorded in the RFID tag, and to perform reporting when completion of payment is not in the RFID tag.

16. The item payment check method according to claim 15, wherein
in the payment process, when performing the recording of payment, information of a payment time is also recorded in the RFID tag, and when the shopping basket passes through the position after a time set in advance has passed since the payment time, reporting is performed.
